(19) United States
(12) Patent Application Publication
(10) Pub. No.: US 2026/0236736 A1
(43) Pub. Date: Aug. 13, 2026

(54) RISK-BASED TRUST SCORING AND OPERATIONALIZATION FRAMEWORK FOR GENERATIVE ARTIFICIAL INTELLIGENCE MODELS

(71) Applicant: FAIR ISAAC CORPORATION, Minneapolis, MN (US)

(72) Inventors: Scott Michael Zoldi, San Diego, CA (US); Krzysztof Michal Nalborski, San Diego, CA (US)

(21) Appl. No.: 19/078,999

(22) Filed: Mar. 13, 2025

Related U.S. Application Data
(60) Provisional application No. 63/756,711, filed on Feb. 10, 2025.

(51) Int. Cl. G06N 3/042; G06N 3/0475; G06N 3/08

(52) U.S. Cl. CPC G06N 3/042; G06N 3/0475; G06N 3/08

(57) ABSTRACT

A method for providing a Generative Artificial Intelligence (GenAI) system with trustworthiness evaluation, wherein the method comprises processing a training dataset that the GenAI was trained upon; constructing a plurality of latent knowledge anchors (LKAs) by applying topic modeling on the processed training dataset, wherein the plurality of LKAs comprises domain-specific knowledge representations within the processed training dataset; training a neural network classifier using the LKAs and the processed training data; evaluating, using the neural network classifier, a response generated by the GenAI to generate a trust score, wherein the trust score indicates the alignment level of the response to the training dataset and/or the comprehensiveness of the response compared to the training dataset; in response to the trust score exceeding a threshold, presenting the response to a user; and in response to the trust score not exceeding the threshold, issuing a command for the GenAI to conduct additional actions.

### CROSS-REFERENCE

This application claims priority to U.S. Patent Application No. 63/756,711, filed Feb. 10, 2025, the contents of which are fully incorporated by reference.

### TECHNICAL FIELD

The present disclosure relates to machine learning-based trust evaluation systems, and more specifically, to systems and methods for assessing the reliability of responses generated by generative artificial intelligence (GenAI) models.

### BACKGROUND

Generative Artificial Intelligence (GenAI) models, such as large language models (LLMs), have gained significant adoption across various domains, including natural language processing, automated content generation, and complex reasoning tasks. These models are trained on vast datasets and utilize probabilistic techniques to generate human-like text based on input prompts. While their capabilities are impressive, concerns remain regarding the trustworthiness and reliability of their outputs.

A primary challenge associated with GenAI systems is their tendency to generate responses that may appear contextually relevant but lack factual accuracy. These inaccuracies, often referred to as hallucinations, can mislead users, particularly in applications requiring precise and verifiable information, such as legal, financial, or medical domains. Due to the non-deterministic nature of these models, two seemingly similar prompts can yield significantly different outputs, further complicating the reliability of their responses.

Additionally, GenAI models are inherently opaque, making it difficult for users to assess whether a given response aligns with the model's training knowledge or if it is influenced by adversarial manipulations, or data sparsity issues. The inability to interpret or validate the reasoning behind generated responses limits the widespread adoption of these models in mission-critical applications.

Existing approaches attempt to mitigate these concerns through human-in-the-loop validation, heuristic-based filtering, or model fine-tuning. However, these methods are either labor-intensive, prone to inconsistencies, or fail to provide real-time assessments of response reliability. As a result, there is a growing need for systematic mechanisms that can evaluate the trustworthiness of GenAI-generated responses, ensuring that only reliable and meaningful outputs are allowed to be presented to a user.

### SUMMARY

Methods, systems, and articles of manufacture, including computer program products, are provided for providing a Generative Artificial Intelligence (GenAI) system with trustworthiness evaluation, wherein the method comprises processing a training dataset that the GenAI was trained upon; constructing a plurality of latent knowledge anchors (LKAs) by applying topic modeling on the processed training dataset, wherein the plurality of LKAs comprises domain-specific knowledge representations within the processed training dataset; training a neural network classifier using the LKAs and the processed training data; evaluating, using the neural network classifier, a response generated by the GenAI to generate a trust score, wherein the trust score indicates the alignment level of the response to the training dataset and/or the comprehensiveness of the response compared to the training dataset; in response to the trust score exceeding a dynamically defined threshold, presenting the response to a user; and in response to the trust score not exceeding the threshold, issuing a command for the GenAI to conduct additional actions.

In some variations, the additional actions comprise generating an additional response, wherein generating an additional response comprises issuing a prompt to the GenAI to refine or supplement the response.

In some variations, training the neural network classifier comprises expanding the training dataset with out-of-domain samples to introduce negative example; generating LKA vectors for in-domain samples and out-of-domain training datasets; and training the neural network classifier using the in-domain and out-of-domain dataset, wherein the classifier is optimized to maximize a separation between in-domain and out-of-domain responses.

In some variations, the out-of-domain training samples are assigned to the neural network classifier's training dataset based on their rank-ordered level of relevance to a predefined in-domain data definitions.

In some variations, the method further comprises: extracting N-gram sequences from the processed training dataset; calculating a frequency of occurrence of each N-gram within the training dataset to establish an N-gram statistical baseline; and generating a N-gram coverage statistics metric associated with the training dataset, wherein the N-gram coverage statistics metric is utilized in calculating the trust score.

In some variations, the method further comprises: converting the response to N-gram representation and LKA vector representations; generating, using the trained classifier, a first score indicating the alignment level of the response with the in-domain LKA space; calculating a second score based on the N-gram representation of the response and the N-gram coverage statistics metric associated with the training dataset; and generating the trust score based on the first score and the second score.

In some variations, the topic modeling for constructing the LKAs comprises applying latent Dirichlet allocation (LDA) topic modeling to the processed training dataset.

In some variations, the processing the training dataset comprises: performing text preprocessing on the training dataset, wherein the text preprocessing includes tokenization, lemmatization, and stopword removal.

In an aspect, provided herein is a computer program product for providing a Generative Artificial Intelligence (GenAI) system with trustworthiness evaluation, comprising a non-transient machine-readable medium storing instructions that, when executed by at least one programmable processor, cause the at least one programmable processor to perform operations including processing a training dataset that the GenAI was trained upon; constructing a plurality of latent knowledge anchors (LKAs) by applying topic modeling on the processed training dataset, wherein the plurality of LKAs comprises domain-specific knowledge representations within the processed training dataset; training a neural network classifier using the LKAs and the processed training data; evaluating, using the neural network classifier, a response generated by the GenAI to generate a trust score, wherein the trust score indicates the alignment level of the response to the training dataset and/or the comprehensiveness of the response compared to the training dataset; in response to the trust score exceeding a dynamically defined threshold, presenting the response to a user; and in response to the trust score not exceeding the threshold, issuing a command for the GenAI to conduct additional actions.

In some variations, the additional actions comprise generating an additional response, wherein generating an additional response comprises issuing a prompt to the GenAI to refine or supplement the response.

In some variations, training the neural network classifier comprises expanding the training dataset with out-of-domain samples to introduce negative example; generating LKA vectors for in-domain samples and out-of-domain training datasets; and training the neural network classifier using the in-domain and out-of-domain dataset, wherein the classifier is optimized to maximize a separation between in-domain and out-of-domain responses.

In some variations, the out-of-domain training samples are assigned to the neural network classifier's training dataset based on their rank-ordered level of relevance to a predefined in-domain data definitions.

In some variations, the operations further include extracting N-gram sequences from the processed training dataset; calculating a frequency of occurrence of each N-gram within the training dataset to establish an N-gram statistical baseline; and generating a N-gram coverage statistics metric associated with the training dataset, wherein the N-gram coverage statistics metric is utilized in calculating the trust score.

In some variations, the operations further includes converting the response to N-gram representation and LKA vector representations; generating, using the trained classifier, a first score indicating the alignment level of the response with the in-domain LKA space; calculating a second score based on the N-gram representation of the response and the N-gram coverage statistics metric associated with the training dataset; and generating the trust score based on the first score and the second score.

In some variations, the topic modeling for constructing the LKAs comprises applying latent Dirichlet allocation (LDA) topic modeling to the processed training dataset.

In some variations, the processing the training dataset comprises: performing text preprocessing on the training dataset, wherein the text preprocessing includes tokenization, lemmatization, and stopword removal.

In an aspect, provided herein is a system for providing a Generative Artificial Intelligence (GenAI) system with trustworthiness evaluation comprising at least one programmable processor; and a non-transient machine-readable medium storing instructions that, when executed by the processor, cause the at least one programmable processor to perform operations including processing a training dataset that the GenAI was trained upon; constructing a plurality of latent knowledge anchors (LKAs) by applying topic modeling on the processed training dataset, wherein the plurality of LKAs comprises domain-specific knowledge representations within the processed training dataset; training a neural network classifier using the LKAs and the processed training data; evaluating, using the neural network classifier, a response generated by the GenAI to generate a trust score, wherein the trust score indicates the alignment level of the response to the training dataset and/or the comprehensiveness of the response compared to the training dataset; in response to the trust score exceeding a dynamically defined threshold, presenting the response to a user; and in response to the trust score not exceeding the threshold, issuing a command for the GenAI to conduct additional actions.

In some variations, the additional actions comprise generating an additional response, wherein generating an additional response comprises issuing a prompt to the GenAI to refine or supplement the response.

In some variations, training the neural network classifier comprises expanding the training dataset with out-of-domain samples to introduce negative example; generating LKA vectors for in-domain samples and out-of-domain training datasets; and training the neural network classifier using the in-domain and out-of-domain dataset, wherein the classifier is optimized to maximize a separation between in-domain and out-of-domain responses.

In some variations, the out-of-domain training samples are assigned to the neural network classifier's training dataset based on their rank-ordered level of relevance to a predefined in-domain data definitions.

In some variations, the operations further include extracting N-gram sequences from the processed training dataset; calculating a frequency of occurrence of each N-gram within the training dataset to establish an N-gram statistical baseline; and generating a N-gram coverage statistics metric associated with the training dataset, wherein the N-gram coverage statistics metric is utilized in calculating the trust score.

In some variations, the operations further includes converting the response to N-gram representation and LKA vector representations; generating, using the trained classifier, a first score indicating the alignment level of the response with the in-domain LKA space; calculating a second score based on the N-gram representation of the response and the N-gram coverage statistics metric associated with the training dataset; and generating the trust score based on the first score and the second score.

In some variations, the topic modeling for constructing the LKAs comprises applying latent Dirichlet allocation (LDA) topic modeling to the processed training dataset.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a diagram illustrating an exemplary architecture of a GenAI system with a trustworthiness evaluation model, in accordance with one or more embodiments of the current subject matter referred to as the trust score risk model.

FIG. 2 illustrates the trust score risk model's pipeline for independent verification of a generative artificial intelligence (GenAI) model's responses, in accordance with one or more embodiments of the current subject matter.

FIG. 3 illustrates the probability density function of trust scores derived from documents categorized as category 1 and category 5, in accordance with one or more embodiments of the current subject matter.

FIG. 4 depicts a block diagram illustrating a computing system consistent with implementations of the current subject matter.

FIG. 5 is a diagram illustrating a flowchart of a process 500 for evaluating trustworthiness in a Generative Artificial Intelligence (GenAI) system, in accordance with one or more embodiments of the current subject matter.

When practical, like labels are used to refer to same or similar items in the drawings.

### DETAILED DESCRIPTION

The details of one or more variations of the subject matter described herein are set forth in the accompanying drawings.

As discussed above, there is a need for a systematic and automated approach to evaluate the trustworthiness of responses generated by generative artificial intelligence (GenAI) models. Given the challenges of hallucinations, data biases, and non-deterministic outputs, existing solutions remain inadequate in providing real-time, scalable, and interpretable trust assessments. A robust framework is required to assess the reliability of GenAI responses dynamically, ensuring that only high-confidence outputs are presented to users while mitigating the risks associated with uncertain or misleading content.

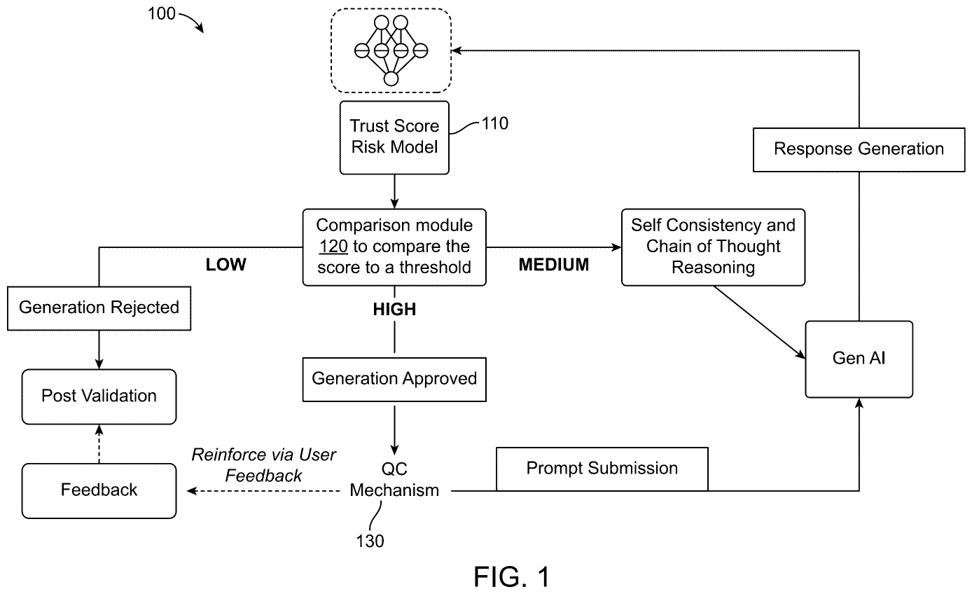

The present disclosure addresses these challenges by introducing a trust evaluation mechanism that enables the automated assessment of GenAI-generated responses. The disclosed system provides a structured approach to determine the degree to which a response aligns with the model's training knowledge and its statistical coverage of relevant domain-specific information. By implementing a trust scoring framework, referred to as the trust score risk model in FIG. 1, the system facilitates the filtering, refinement, and validation of generated responses before they are presented to end users. The following sections describe the technical components and methodologies underlying this approach.

FIG. 1 is a diagram illustrating an exemplary architecture of a GenAI system 100 with a trustworthiness evaluation model, in accordance with one or more embodiments of the current subject matter. As shown in FIG. 1, the GenAI system 100 includes a trust score risk model 110 that evaluates the reliability of responses generated by the GenAI model. The process starts with a prompt submission from a user, which is processed by the GenAI model to generate a response. The generated response is then evaluated by the trust score risk model 110 to compute a trust score. The computed trust score is passed to a comparison module 120, which compares the score against a predefined threshold to categorize the response into three levels.

Low Trust Score: If the trust score is below the threshold, the response is rejected. In some embodiments, the predefined threshold is dynamically defined based on response characteristics, including domain specificity, response length, and historical user feedback. The system may adjust the threshold dynamically in real-time to optimize accuracy and reliability in trust score assessments. The system then initiates a post-validation step to analyze the rejected response. User feedback may also be incorporated to improve future responses. Medium Trust Score: For responses with a medium trust score, the system invokes self-consistency checks and chain-of-thought reasoning within the GenAI model to refine or supplement the response. High Trust Score: If the trust score is above the threshold, the response is forwarded to a quality control mechanism 130 for final verification before being presented to the user.

The architecture incorporates a feedback loop that allows rejected or refined responses to be used as training inputs to improve the evaluation capabilities of the trust score risk model 110 and enhance the accuracy of the GenAI model over time. The diagram highlights a dynamic process that categorizes responses, applies refinement actions when needed, and ensures that only high-confidence outputs are presented to the user, improving reliability and user satisfaction.

In some embodiments, the trust score risk model 110 may generate the trust score by evaluating a response generated by the GenAI model using a combination of an LKA alignment score and an N-gram coverage score. The LKA alignment score is computed by determining the degree to which the response aligns with the latent knowledge anchors (LKAs) constructed from a processed training dataset. The N-gram coverage score is calculated based on the statistical coverage of N-gram sequences extracted from the training dataset, reflecting the comprehensiveness of the response in comparison to the training data. These two scores are then merged to generate the trust score, which serves as an indicator of both the alignment level of the response to the training dataset and its overall comprehensiveness.

### LKA Alignment Score Calculation

In some embodiments, the trust score risk model 110 calculates the LKA alignment score by evaluating the alignment of a response generated by the GenAI model with the latent knowledge anchors (LKAs) derived from the training dataset. This process involves several stages:

Raw Document Data Processing: The LLM's domain- or task-specific data is processed to convert raw text into an N-gram representation. In the preferred embodiment, all documents are converted to their bigram representation, which consists of sequences of two consecutive words. These bigrams are then filtered based on part-of-speech (POS) tags to capture meaningful co-occurrence relationships between words in the corpus. In some embodiments, the LKA construction process incorporates a specialized domain-specific vocabulary derived from the training dataset. This vocabulary is selected based on domain-relevant terminology and may be refined using linguistic techniques such as part-of-speech filtering, term frequency analysis, and external domain-specific lexicons to ensure the most relevant concepts are captured. The processing pipeline includes the following operations:
Tokenization: Text documents are tokenized into individual word strings (tokens), removing punctuation and stop words, and retaining only alphanumeric words no shorter than three characters.
Lemmatization: Tokens are lemmatized to their base forms (e.g., “financed” becomes “finance”).
Bigram Generation: Bigrams are generated from the lemmatized tokens.
POS Tagging and Filtering: Bigrams are POS-tagged and filtered to ensure only certain parts of speech co-occur. In the preferred embodiment, the following POS tag combinations are allowed, according to the English Penn Treebank POS tag set:

$$JJ + NN ( an adjective + a singular noun )$$

$$NN + NN ( a singular noun + a singular noun )$$

$$VB + NN ( a verb + a singular noun )$$

$$NN + VB ( a singular noun + a verb )$$

For example, in a financial context, the bigram “economic growth” (JJ+NN) may be considered, while in a medical context, “heart disease” (NN+NN) may be relevant. In alternative embodiments, different types of N-grams, such as trigrams, can be generated and filtered for different POS tag combinations, like an adjective+a singular noun+a singular noun. This processing pipeline produces arrays of bigrams, which are subsequently used for topic modeling.

Based on the POS-tag filtered N-grams in a numeric term frequency-inverse document frequency (TF-IDF) form, a machine learning model is trained to uncover underlying topics within the LLM's domain- or task-specific training data. In the preferred embodiment, these underlying topics are defined as latent knowledge anchors (LKAs), representing distinct sub-domains within the larger domain of the LLM's training data corpus. LKAs are uncovered considering a specific and contained vocabulary (V) of size S, representing the POS-tag filtered N-grams. The creation of a bounded vocabulary is crucial, allowing granular control of linguistic patterns and efficient representations of a given domain's nomenclature as N-grams. Assuming an a priori dictionary is not provided, a vocabulary is constructed from the training data corpus by analyzing all documents to extract unique N-grams. The vocabulary size is bounded and controlled by an external parameter S. In the preferred embodiment, once the vocabulary is algorithmically established, an AI scientist audits all the N-grams within the vocabulary to maintain observability, traceability, and auditability. An AI scientist should always be part of the vocabulary creation stage to capture every aspect of data and LLM model development.

In the preferred embodiment, a latent Dirichlet allocation (LDA) algorithm is used for topic modeling. The LDA algorithm allows the LLM's training data to be explained by a T-number (e.g., 10) of hidden topics representing LKAs, describing why certain N-gram-transformed text documents are similar. The LDA model training iteratively updates the topic assignments for each N-gram in the vocabulary until convergence. In alternative embodiments, different generative probabilistic or non-probabilistic linear algebraic models, such as non-negative matrix factorization (NMF), can be used to uncover the LKAs. Once completed, the topic modeling stage converts the LLM's training data into T-dimensional (e.g., 10) LKA vectors.

Neural Network Training and Inference: In this stage, the LLM's domain- or task-specific dataset is expanded with additional exemplars outside of the domain to train a neural network classifier to discriminate between in-domain and out-of-domain data. Both the in-domain and out-of-domain data are processed using the aforementioned stages to generate T-dimensional LKA vectors. Following training, a raw neural network score is calibrated to a [1, 999] range. In some embodiments, out-of-domain samples are specifically introduced as negative examples during classifier training. These samples are selected based on their deviation from the specialized domain-specific vocabulary and LKA structures. The classifier is trained to assign lower scores to responses resembling out-of-domain samples, ensuring that trust scores reflect domain alignment. During the process of an independent LLM's response verification, the trained neural network model is used in inference mode to verify whether the domain-specific LKAs that the LLM was trained on are utilized by the LLM to provide a response to a specific prompt. The closer the score is to 999, the higher the probability that the LLM's response to a given prompt is within the latent knowledge anchor space of the in-domain data. High scores provide LLM users with greater confidence in the LLM and its responses. In alternative embodiments, different machine learning classifiers, such as decision trees or support vector machines, can be used to learn to discriminate between in-domain and out-of-domain data.

### Response Coverage Score Calculation

In some embodiments, the trust score risk model calculates the N-gram coverage of a response generated by the GenAI model with respect to the latent knowledge anchors (LKAs) underlying the response as a second component of the trust score. To achieve this, the system performs multiple stages of processing and evaluation. Initially, each N-gram in the in-domain vocabulary, constructed during the LDA modeling process, is assigned a coverage statistic. This statistic represents the frequency of an N-gram's occurrence across the training dataset and is calculated as the percentage of documents within the training corpus that include at least one instance of the n-gram. For example, the N-gram coverage percentage is defined as the number of documents containing a specific N-gram divided by the total number of documents in the in-domain training set, multiplied by 100. These coverage statistics are stored in a database for independent verification of responses.

For each LKA, a summarization process is performed by identifying a predefined number (e.g., 50) of the most relevant N-grams associated with the LKA. In some embodiments, the system constructs coverage statistical measures specifically over a specialized domain-specific vocabulary. These measures quantify relationships of co-occurrence between tokens in the vocabulary, allowing the system to track term relevance and domain specificity. This statistical representation enhances the ability to assess trust scores by providing a structured measure of linguistic coherence and domain alignment. These N-grams are identified algorithmically, leveraging the LDA model's weights, and optionally validated through human expertise to ensure domain relevance. For each selected N-gram, the corresponding coverage statistic is retrieved, and both the mean and standard deviation of these values are calculated to represent the overall coverage characteristics of the LKA. These summarization statistics are stored in a database to facilitate the comparison and evaluation of responses. For instance, if an LKA represents personal finance, its relevant N-grams might include terms such as “credit score,” “credit card,” and “credit report,” each with individual coverage percentages. The mean coverage and standard deviation of a predefined number (e.g., 50) of the most relevant N-grams associated with the LKA provide a comprehensive overview of how these terms are distributed across the training data and in relation to each LKA. In another example, if an LKA represents medical diagnostics, its relevant N-grams might include terms such as “blood pressure,” “heart rate,” and “MRI scan,” each with individual coverage percentages reflecting their prevalence in the training dataset. For instance, “blood pressure” may have a coverage percentage of 6.75%, “heart rate” 4.32%, and “MRI scan” 3.89%. The mean coverage and standard deviation for this LKA are calculated to provide a statistical overview of how these terms are distributed across the medical dataset. These statistical values are stored and later used for evaluating the comprehensiveness of GenAI-generated responses in the medical domain. In some embodiments, an in-domain LKA space is formed by consolidating the LKA vectors corresponding to in-domain samples. This consolidation process aggregates the learned LKA representations into a structured space that characterizes the key knowledge areas within the training dataset. By defining a well-bounded in-domain space, the system improves response evaluation accuracy. If a response includes medical terminology but deviates from the expected LKA-based coverage, its trust score may be adjusted accordingly to reflect potential gaps in domain knowledge representation.

To evaluate a specific response generated by the GenAI model, the response is first converted into an N-gram representation and then mapped to an LKA vector. The N-grams within the response are compared against the in-domain vocabulary to determine the mutual elements. For instance, if a response contains 30 N-grams and 20 of them are found in the in-domain vocabulary, the system retrieves the coverage statistics for these 20 N-grams. Using an arithmetic mean formula, the system calculates the mean coverage value (MC) for the response. The LKA vector, which includes elements equal to the total number of LKAs (e.g., 10), is used to identify the LKA most strongly associated with the response. The LKA's mean and standard deviation coverage values are then retrieved from the summarization database for further calculations.

To standardize the MC, the system computes a z-score (referred to as the MC z-score) using the formula: (MC-LKA's mean)/LKA's standard deviation. The z-score is capped to a range of [−3, 0], where values below the LKA's mean and within three standard deviations are retained. The MC z-score is subsequently calibrated to a range of [1, 999], with any z-score value greater than or equal to 0.0 automatically mapped to 999. The calibrated score is further weighted by the probability of the LKA most likely associated with the response. This weighting ensures that the system accounts for cases where responses with similar coverage metrics may differ semantically based on the LKA space they align with. In an alternative embodiment, for responses that cannot be distinctly assigned to a single LKA, the system may consider bigram information from two or three LKAs with the highest probabilities.

The resulting N-gram coverage score reflects how comprehensive and representative the response is in relation to the target domain and its specific LKA. A higher coverage score, approaching 999, indicates a higher level of comprehensiveness and alignment with the in-domain knowledge. In the preferred embodiment, this process is supplemented by retrieving a specified number of relevant documents from the in-domain database, identified using a cosine similarity measure based on the LKA vectors. These documents provide additional context and validation for the response, further enhancing the system's trustworthiness evaluation capabilities.

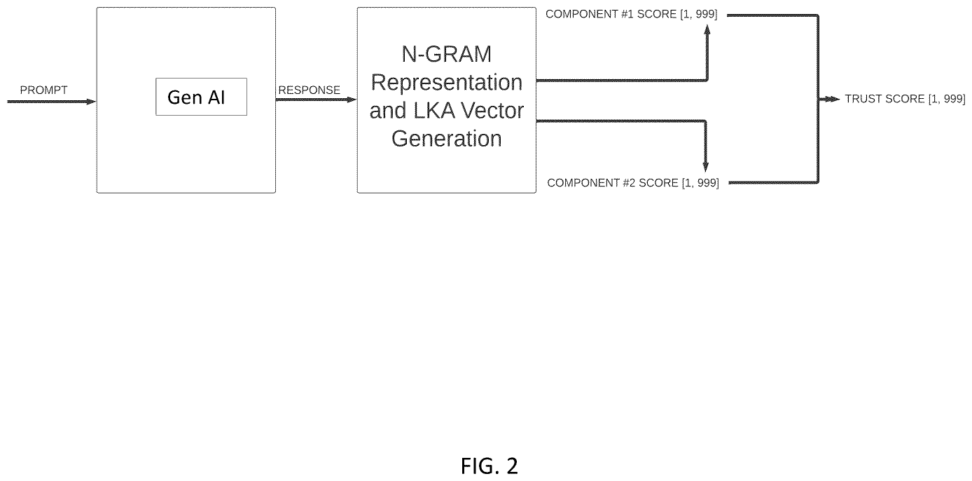

FIG. 2 illustrates the trust score risk model's pipeline for independent verification of a generative artificial intelligence (GenAI) model's responses. The diagram depicts the sequential process through which a trust score is generated based on two core components: the latent knowledge anchor (LKA) alignment score and the N-gram coverage score. As shown in FIG. 2, when a prompt is submitted to the GenAI model, the system generates a response. This response is simultaneously processed to produce both an N-gram representation and an LKA vector. These representations are then used as input for two parallel evaluation processes. Component #1 calculates an LKA alignment score by assessing how well the response aligns with the in-domain knowledge represented by the LKAs derived during the training process. Component #2 computes the N-gram coverage score by comparing the response's N-grams against the statistical distribution of N-grams from the in-domain training dataset. Both component scores are scaled within a range of [1, 999] and are then combined to produce the final trust score. The combination of these scores may involve arithmetic averaging, probabilistic merging, or machine learning-based mappings that account for nonlinear interactions between the two components. In some embodiments, the neural network classifier integrates the LKA alignment score and the statistical coverage measures to compute the trust score. By combining these two components, the classifier accounts for both conceptual alignment with in-domain knowledge and statistical consistency with the training dataset, enhancing the accuracy of response evaluations. The resulting trust score represents the overall reliability of the response, with higher scores indicating a greater alignment with domain-specific knowledge and comprehensiveness.

The pipeline described in FIG. 2 is optimized for real-time applications and large-scale API deployments. Using latent Dirichlet allocation (LDA) technology, the system is capable of processing trust score evaluations efficiently. The computational latency of trust score inference is designed to be lower than the GenAI model's response generation time, ensuring that the trust score can be computed rapidly and without affecting the timeliness of the overall system. This makes the approach suitable for scenarios requiring prompt evaluations, such as real-time user interactions or large-scale deployment environments.

### Case Study

To demonstrate the novelty and value of this invention, a case study was conducted to evaluate the trust score risk model. The case study used a Focused Language Models (FLMs) trained on medical diagnostics domain data (further referred to as in-domain data). A FLM is a version of a large language model (LLM) specifically designed and trained to achieve reliable and trustworthy results within a narrow domain or task. In this case, the medical diagnostics domain was selected. FLMs are highly specialized because they are trained on carefully filtered and selected data sets relevant to the intended task. This reduces the likelihood of generating nonsensical information (known as hallucinations) and increases confidence in the generated outputs. After training the base (domain adaptation) FLM, additional task-specific FLMs were fine-tuned on specialized diagnostics tasks (e.g., identifying potential symptoms or analyzing lab results). FLMs allow granular control of language and linguistic patterns because they are built on bounded vocabularies created from high-quality and audited data sets.

The in-domain data included 56,390,304 documents from the medical diagnostics industry. These documents were categorized into five levels of relevance:
Category 1: Document content has minimal relevant medical diagnostics information; mostly irrelevant or promotional.
Category 2: Document mentions medical diagnostics concepts but lacks depth; contains significant irrelevant content.
Category 3: Document clearly introduces key medical diagnostics concepts and terminology; focused on medical topics with minimal extraneous information.
Category 4: Document is highly relevant and valuable; provides substantial information with examples or case studies; minimal irrelevant content.
Category 5: Document is an exceptional educational resource; well-organized, highly informative, with deep insights into medical diagnostics; free from irrelevant content.

The training of the trust score risk model included the following stages:

LKAs Generation: To identify the latent knowledge anchors within the FLM's data corpus, only documents of category 5 (837,016 in total) were used. These documents were converted into their bigram representations and transformed into numeric TF-IDF forms to train the LDA model. The final vocabulary size VVV was 262,144. For each bigram, a coverage statistic was calculated as follows:

$$A bigram coverage \% = ( \# of documents including at least 1 occurrence of a given bigram / 56 , 390 , 304 ) \times 100$$

Bigram-specific coverage statistics were stored in a database. Although the vocabulary was created only from category 5 documents, the denominator for the formula included the entirety of the FLM's training data (categories 3, 4, and 5).

The LDA model identified TTT-number of latent knowledge anchors, where T=10T=10T=10. An AI scientist conducted an analysis of the most relevant bigrams for each topic and assigned LKA-related categories such as:
i. Diagnostic Imaging Techniques
ii. Pathology and Lab Results Analysis
iii. Disease Symptom Classification
iv. Preventive Healthcare Protocols
v. Treatment Outcome Prediction
vi. Patient Risk Stratification
vii. Drug Efficacy Monitoring
viii. Genetic and Biomarker Analysis
ix. Mental Health Assessment
x. Surgical Success Probability Models

For each LKA, summarization statistics were generated and stored in a database. All 837,016 documents were converted into LKA vectors following the LDA training process.

Neural Network Training: A dataset was created for training a neural network classifier. This included 837,016 documents from category 5 represented as LKA vectors and 771,270 documents from category 1 also represented as LKA vectors. The neural network, consisting of one hidden layer with six nodes, was trained for 200 epochs.

After training, the trust score risk model's pipeline was tested on a holdout dataset of 250,000 documents sampled evenly across all five categories. The trust score for each document was computed as the arithmetic mean of the component #1 (LKA alignment) and component #2 (N-gram coverage) scores.

TABLE 1
Trust Score Distribution Table for the Holdout Data

| | cumulative % of | cumulative % of | cumulative % of | cumulative % of | cumulative % of |
|---|---|---|---|---|---|
| trust score | category 1 | category 2 | category 3 | category 4 | category 5 |
| range | above the range | above the range | above the range | above the range | above the range |
| [1, 100] | 99.09 | 100.00 | 100.00 | 100.00 | 100.00 |
| (100, 200] | 88.14 | 91.00 | 95.86 | 98.36 | 99.45 |
| (200, 300] | 60.48 | 69.65 | 83.02 | 91.86 | 96.73 |
| (300, 400] | 34.18 | 50.78 | 68.43 | 82.30 | 90.91 |
| (400, 500] | 19.88 | 34.20 | 53.04 | 69.19 | 80.11 |
| (500, 600]* | 10.87 | 19.35 | 36.57 | 53.57 | 67.97 |
| (600, 700]* | 3.74 | 5.73 | 17.06 | 29.99 | 45.34 |
| (700, 800] | 0.97 | 1.32 | 5.58 | 11.51 | 21.18 |
| (800, 900] | 0.03 | 0.06 | 0.33 | 0.94 | 2.97 |
| (900, 999] | 0.00 | 0.00 | 0.00 | 0.00 | 0.00 |

Table 1 demonstrates the trust score risk model's ability to differentiate between in-domain and out-of-domain documents. For example, with a trust score threshold of >600, approximately 11% of category 1 documents are included, compared to 68% of category 5 documents. Similarly, a threshold of >700 retains only ~4% of category 1 documents, but 45% of category 5 documents.

The case study illustrates the trust score risk model's efficacy in identifying reliable and relevant responses for highly specialized domains such as medical diagnostics, supporting its applicability across diverse real-world scenarios.

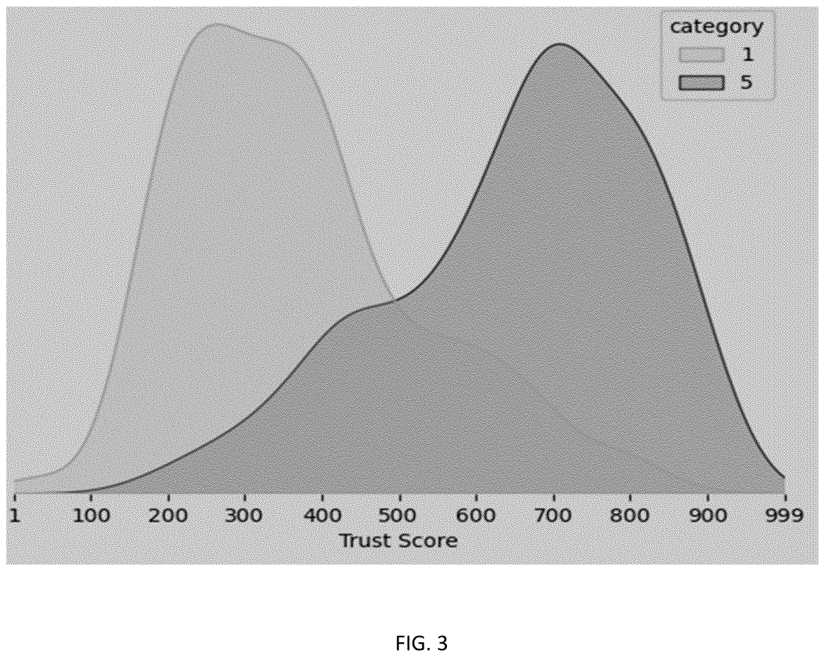

FIG. 3 illustrates the probability density function of trust scores derived from documents categorized as category 1 and category 5, according to one or more embodiments. As shown in FIG. 3, binning and observation counting are utilized to generate a kernel density estimate plot, smoothing the observed data with a Gaussian kernel to produce a continuous density distribution. This visualization demonstrates the effectiveness of the trust score risk model in distinguishing between in-domain and out-of-domain data. Specifically, documents from category 5, which are highly relevant and accurate, show a higher density of trust scores concentrated in the upper range, reflecting their strong alignment with domain-specific knowledge. In contrast, documents from category 1, which are minimally relevant or irrelevant, exhibit trust scores predominantly in the lower range. This differentiation validates the robustness of the trust score risk model in accurately categorizing and evaluating generative artificial intelligence (GenAI) responses.

The following example illustrates the inference process using the trust score risk model to independently verify a response generated by a focused language model (FLM). A prompt is submitted to the FLM: “What are common symptoms of diabetes?” The FLM generates the response: “Common symptoms of diabetes include increased thirst, frequent urination, extreme hunger, unintended weight loss, fatigue, blurred vision, slow-healing sores, and frequent infections. These symptoms are more noticeable in type 1 diabetes but can also occur in type 2 diabetes. It's essential to consult a healthcare provider for proper diagnosis and management.” This response is processed into its bigram representation and latent knowledge anchor (LKA) vector.

For example, the bigram array for the response includes phrases such as [‘common symptom’, ‘symptom diabetes’, ‘include increase’, ‘increase thirst’, ‘frequent urination’, ‘extreme hunger’, ‘unintended weight’, ‘weight loss’, ‘loss fatigue’, ‘fatigue blurred’, ‘blurred vision’, ‘slow-healing sores’, ‘frequent infection’, ‘symptom noticeable’, ‘type diabetes’, ‘consult healthcare’, ‘healthcare provider’, ‘provider proper’, ‘proper diagnosis’, ‘diagnosis management’], and the corresponding LKA vector is [0.000123, 0.998652, 0.000245, 0.000342, 0.000198, 0.000276, 0.000321, 0.000145, 0.000267, 0.000132].

Analysis of the LKA vector identifies LKA at index 1 (zero-based indexing) as the most probable match, representing the disease symptom classification subdomain in the medical diagnostics domain. The LKA vector is further processed by a neural network classifier to evaluate the response's alignment with the latent knowledge anchors, resulting in an alignment score of 915. Simultaneously, the bigram array is analyzed to calculate the response's n-gram coverage relative to the latent knowledge anchors, yielding an N-gram coverage score of 821. These two scores are combined as an arithmetic mean to derive the final trust score, which is 868 in this case. This high trust score indicates that the response is both well-aligned with the in-domain knowledge and comprehensive in its coverage.

To further validate the response, five highly relevant documents from the in-domain database are retrieved based on cosine similarity measures. These documents provide additional context for the response and are presented in Table 2.

| Text Snippet | URL/file location |
|---|---|
| Symptoms of early diabetes . . . | example. File location/URL |
| Managing diabetes complications . . . | example. File location/URL |
| How type 2 diabetes differs . . . | example. File location/URL |
| Understanding blood sugar levels . . . | example. File location/URL |
| Common medications for diabetes . . . | example. File location/URL |

With a trust score of 868, the system confidently verifies that the response is accurate, comprehensive, and representative of the target domain. The retrieved documents further reinforce the reliability of the GenAI system's outputs, enhancing user trust in the response evaluation process.

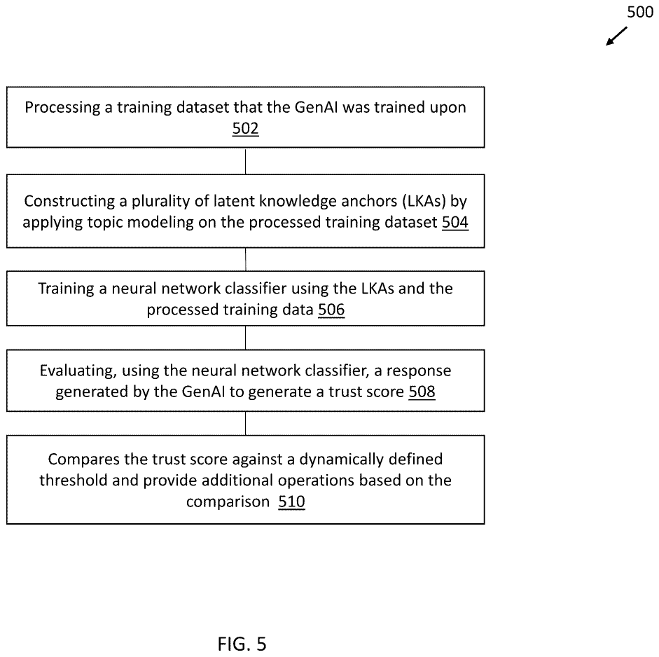

FIG. 5 is a diagram illustrating a flowchart of a process 500 for evaluating trustworthiness in a Generative Artificial Intelligence (GenAI) system, in accordance with one or more embodiments of the current subject matter. As shown in FIG. 5, the process 500 may begin with operation 502, wherein the system processes a training dataset that the GenAI was trained upon. In some embodiments, this includes performing text preprocessing such as tokenization, lemmatization, and stopword removal to prepare the dataset for further analysis. The process may then proceed to operation 504, where the system constructs a plurality of latent knowledge anchors (LKAs) by applying a topic modeling mechanism to the processed training dataset. In some embodiments, the topic modeling mechanism involves latent Dirichlet allocation (LDA) or other probabilistic techniques to generate domain-specific knowledge representations within the training dataset. Each LKA represents a specific subdomain of the knowledge space. Next, in operation 506, the system trains a neural network classifier using the LKAs and the processed training dataset. The training process involves generating LKA vectors for in-domain data and augmenting the training dataset with out-of-domain data samples to introduce negative examples. The classifier is trained to maximize the separation between in-domain and out-of-domain responses by assigning higher LKA alignment scores to in-domain data and proportionally lower scores to out-of-domain data. The process advances to operation 508, where the system evaluates a response generated by the GenAI system and generates a trust score. The evaluation includes generating two component scores: a first score indicating the response's alignment level with the LKAs and a second score derived from an analysis of the response's N-gram coverage with respect to the statistical baseline established from the training dataset. The trust score is calculated by combining these two component scores through methods such as arithmetic averaging, probabilistic merging, or other statistical techniques. At operation 510, the system compares the trust score against a dynamically defined threshold. If the trust score exceeds the threshold, the process proceeds to presenting the response to the user. If the trust score does not exceed the threshold, the process advances to issuing a command to the GenAI to conduct additional actions. These additional actions may include generating an additional response by issuing a refined prompt to the GenAI to improve or supplement the response.

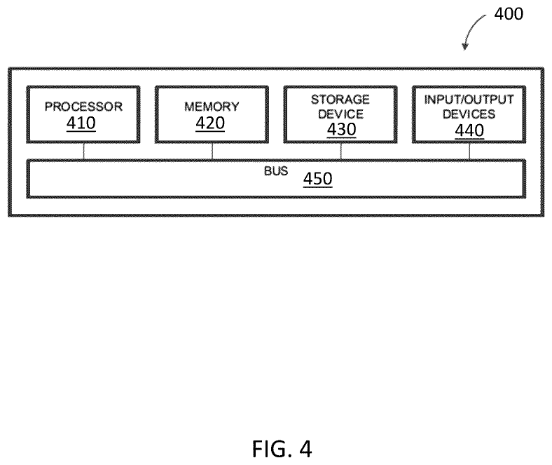

FIG. 4 depicts a block diagram illustrating a computing system 400 consistent with implementations of the current subject matter. As shown in FIG. 4, the computing system 400 can include a processor 410, a memory 420, a storage device 430, and input/output devices 440. The processor 410, the memory 420, the storage device 430, and the input/output devices 440 can be interconnected via a system bus 450. The computing system 400 may additionally or alternatively include a graphic processing unit (GPU), such as for image processing, and/or an associated memory for the GPU. The GPU and/or the associated memory for the GPU may be interconnected via the system bus 450 with the processor 410, the memory 420, the storage device 430, and the input/output devices 440. The memory associated with the GPU may store one or more images described herein, and the GPU may process one or more of the images described herein. The GPU may be coupled to and/or form a part of the processor 410. The processor 410 is capable of processing instructions for execution within the computing system 400. Such executed instructions can implement one or more components. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method for providing a Generative Artificial Intelligence (GenAI) system with trustworthiness evaluation, comprising:
processing a training dataset that the GenAI was trained upon;
constructing a plurality of latent knowledge anchors (LKAs) by applying topic modeling on the processed training dataset, wherein the plurality of LKAs comprises domain-specific knowledge representations within the processed training dataset and specialized domain-specific vocabulary;
constructing a plurality of coverage statistical measures over a specialized domain specific vocabulary where the statistical measures quantify a statistical relevance of relationships of co-occurrence between tokens on the vocabulary;
training a neural network classifier using the LKAs and the processed training data;
evaluating, using the neural network classifier and statistical coverage measures, a response generated by the GenAI to generate a trust score, wherein the trust score indicates an alignment level of the response to the training dataset given a specialized domain-specific vocabulary and/or a comprehensiveness of the response compared to the training dataset;
in response to the trust score exceeding a dynamically defined threshold, presenting the response to a user; and
in response to the trust score not exceeding the threshold, issuing a command for the GenAI to conduct additional actions.

2. The method of claim 1, wherein the additional actions comprise generating an additional response, wherein generating an additional response comprises issuing a prompt to the GenAI to refine or supplement the response.

3. The method of claim 1, wherein training the neural network classifier comprises:
expanding the training dataset with out-of-domain samples to introduce negative example;
generating LKA vectors for in-domain samples and out-of-domain training datasets, wherein an in-domain LKA space is formed by consolidating the LKA vectors for the in-domain samples;
training the neural network classifier using the in-domain and out-of-domain dataset, wherein the classifier is optimized to maximize a separation between in-domain and out-of-domain responses.

4. The method of claim 1, further comprising:
extracting N-gram sequences from the processed training dataset;
calculating a frequency of occurrence of each N-gram within the training dataset to establish an N-gram statistical baseline; and
generating a N-gram coverage statistics metric associated with the training dataset, wherein the N-gram coverage statistics metric is utilized in calculating the trust score.

5. The method of claim 4, further comprising:
converting the response to N-gram representation and LKA vector representations;
generating, using the trained classifier, a first score indicating the alignment level of the response with an in-domain LKA space;
calculating a second score based on the N-gram representation of the response and the N-gram coverage statistics metric associated with the training dataset; and
generating the trust score based on the first score and the second score.

6. The method of claim 1, wherein the topic modeling for constructing the LKAs comprises applying latent Dirichlet allocation (LDA) topic modeling to the processed training dataset.

7. The method of claim 1, wherein the processing the training dataset comprises: performing text preprocessing on the training dataset, wherein the text preprocessing includes tokenization, lemmatization, and stopword removal.

8. A computer program product for providing a Generative Artificial Intelligence (GenAI) system with trustworthiness evaluation, comprising a non-transient machine-readable medium storing instructions that, when executed by at least one programmable processor, cause the at least one programmable processor to perform operations comprising:
processing a training dataset that the GenAI was trained upon;
constructing a plurality of latent knowledge anchors (LKAs) by applying topic modeling on the processed training dataset, wherein the plurality of LKAs comprises domain-specific knowledge representations within the processed training dataset and specialized domain-specific vocabulary;
constructing a plurality of coverage statistical measures over a specialized domain specific vocabulary where the statistical measures quantify a statistical relevance of relationships of co-occurrence between tokens on the vocabulary;
training a neural network classifier using the LKAs and the processed training data;
evaluating, using the neural network classifier and statistical coverage measures, a response generated by the GenAI to generate a trust score, wherein the trust score indicates an alignment level of the response to the training dataset given a specialized domain-specific vocabulary and/or a comprehensiveness of the response compared to the training dataset;
in response to the trust score exceeding a dynamically defined threshold, presenting the response to a user; and
in response to the trust score not exceeding the threshold, issuing a command for the GenAI to conduct additional actions.

9. The computer program product of claim 8, wherein the additional actions comprise generating an additional response, wherein generating an additional response comprises issuing a prompt to the GenAI to refine or supplement the response.

10. The computer program product of claim 8, wherein training the neural network classifier comprises:
expanding the training dataset with out-of-domain samples to introduce negative example;
generating LKA vectors for in-domain samples and out-of-domain training datasets, wherein an in-domain LKA space is formed by consolidating the LKA vectors for the in-domain samples;
training the neural network classifier using the in-domain and out-of-domain dataset, wherein the classifier is optimized to maximize a separation between in-domain and out-of-domain responses.

11. The computer program product of claim 8, wherein the operations further comprise:
extracting N-gram sequences from the processed training dataset;
calculating a frequency of occurrence of each N-gram within the training dataset to establish an N-gram statistical baseline; and
generating a N-gram coverage statistics metric associated with the training dataset, wherein the N-gram coverage statistics metric is utilized in calculating the trust score.

12. The computer program product of claim 11, wherein the operations further comprise:
converting the response to N-gram representation and LKA vector representations;
generating, using the trained classifier, a first score indicating the alignment level of the response with an in-domain LKA space;
calculating a second score based on the N-gram representation of the response and the N-gram coverage statistics metric associated with the training dataset; and
generating the trust score based on the first score and the second score.

13. The computer program product of claim 8, wherein the topic modeling for constructing the LKAs comprises applying latent Dirichlet allocation (LDA) topic modeling to the processed training dataset.

14. The computer program product of claim 8, wherein the processing the training dataset comprises: performing text preprocessing on the training dataset, wherein the text preprocessing includes tokenization, lemmatization, and stopword removal.

15. A system for providing a Generative Artificial Intelligence (GenAI) system with trustworthiness evaluation comprising:
at least one programmable processor; and
a non-transient machine-readable medium storing instructions that, when executed by the processor, cause the at least one programmable processor to perform operations comprising:
processing a training dataset that the GenAI was trained upon;
constructing a plurality of latent knowledge anchors (LKAs) by applying topic modeling on the processed training dataset, wherein the plurality of LKAs comprises domain-specific knowledge representations within the processed training dataset and specialized domain-specific vocabulary;
constructing a plurality of coverage statistical measures over a specialized domain specific vocabulary where the statistical measures quantify a statistical relevance of relationships of co-occurrence between tokens on the vocabulary;
training a neural network classifier using the LKAs and the processed training data;
evaluating, using the neural network classifier and statistical coverage measures, a response generated by the GenAI to generate a trust score, wherein the trust score indicates an alignment level of the response to the training dataset given a specialized domain-specific vocabulary and/or a comprehensiveness of the response compared to the training dataset;
in response to the trust score exceeding a dynamically defined threshold, presenting the response to a user; and
in response to the trust score not exceeding the threshold, issuing a command for the GenAI to conduct additional actions.

16. The system of claim 15, wherein the additional actions comprise generating an additional response, wherein generating an additional response comprises issuing a prompt to the GenAI to refine or supplement the response.

17. The system of claim 15, wherein training the neural network classifier comprises:
expanding the training dataset with out-of-domain samples to introduce negative example;
generating LKA vectors for in-domain samples and out-of-domain training datasets, wherein an in-domain LKA space is formed by consolidating the LKA vectors for the in-domain samples;
training the neural network classifier using the in-domain and out-of-domain dataset, wherein the classifier is optimized to maximize a separation between in-domain and out-of-domain responses.

18. The system of claim 15, wherein the operations further comprise:
extracting N-gram sequences from the processed training dataset;
calculating a frequency of occurrence of each N-gram within the training dataset to establish an N-gram statistical baseline; and
generating a N-gram coverage statistics metric associated with the training dataset, wherein the N-gram coverage statistics metric is utilized in calculating the trust score.

19. The system of claim 18, wherein the operations further comprise:
converting the response to N-gram representation and LKA vector representations;
generating, using the trained classifier, a first score indicating the alignment level of the response with an in-domain LKA space;
calculating a second score based on the N-gram representation of the response and the N-gram coverage statistics metric associated with the training dataset; and
generating the trust score based on the first score and the second score.

20. The system of claim 15, wherein the topic modeling for constructing the LKAs comprises applying latent Dirichlet allocation (LDA) topic modeling to the processed training dataset.
